(19) United States
(12) Patent Application Publication
(10) Pub. No.: US 2010/0163415 A1
(43) Pub. Date: Jul. 1, 2010

(54) WATER TREATMENT DEVICE

(75) Inventors: Vincent Alan Resor, Dublin, OH (US); Loyd Nels Cutchall, Ashtabula, OH (US); Christopher Charles Mace, Pickerington, OH (US); Alan Neil Sosebee, Grove City, OH (US); Richard James Winter, Ray, MI (US)

Correspondence Address: STANDLEY LAW GROUP LLP, 6300 Riverside Drive, Dublin, OH, 43017, US

(73) Assignee: CHARDON LABORATORIES, INC., Reynoldsburg, OH (US)

(21) Appl. No.: 12/346,728

(22) Filed: Dec. 30, 2008

(51) Int. Cl. B03C 5/00; B03C 5/02

(52) U.S. Cl. 204/554; 204/669

(57) ABSTRACT

A water treatment device having a tank containing an anode and a cathode. A motor is provided to impart rotational motion to the cathode. A scraping means is fixed to the interior of the tank and extend inward toward the tank so as to define a gap between the scraping means and the cathode. As mineral deposits accumulate on the cathode they are removed by the scraping means and the rotational motion of the cathode.

### TECHNICAL FIELD

Exemplary embodiments relate to a water treatment device. More particularly, exemplary embodiments relate to a mechanical water treatment device employing electrical current to remove impurities from water.

### BACKGROUND AND SUMMARY OF THE INVENTION

Large cooling systems and other systems employing recirculating water may require water treatment. Water treatment may be required to prevent scale build-up, fouling from settlement solids, microbiological growth, and system corrosion. Calcium carbonate scale is a significant problem for recirculating water systems as it precipitates on heat exchange surfaces. This build-up of scale causes the water recirculating system to work harder and expend more energy to accomplish the same level of cooling. This in turn increases the cost to operate the recirculating water system.

Corrosion is another problem that must be overcome in the operation of a recirculating water system. Corrosion is of particular concern with respect to ferrous metal components in the recirculating water system. Corrosion may dramatically shorten the life span of key components common to most recirculating water systems. One of the primary culprits in the corrosion found in recirculating water systems is calcium ions.

Microbiological growth is another major concern in the operation of recirculating water systems. Cooling towers used in recirculating water systems are a natural place for algae and bacteria to grow and cause serious problems if microbiological controls are not in place. Microbes may grow within the cooling tower and present serious corrosion issues and other potential issues, if not controlled. Along with microbiological growth, mud may also be a concern as cycles of concentration increase in the cooling towers. The combination of microbiological growth and mud may lead to airborne contaminants.

Fouling from settleable deposits is another concern in the operation of recirculating water systems. As the solids settle they may reduce the flow through components of the recirculating water system. In addition, underdeposit corrosion may be caused by the settlement of solids.

Traditionally, to combat the problems associated with recirculating water systems chemical systems have been employed. This form of water treatment requires the addition of chemicals to the water in an attempt to prevent scaling, microbiological growth, and system corrosion. Although the addition of chemicals into the water may help alleviate some of the problems associated with recirculating water systems problems may still remain. In addition, chemical water treatment is costly, may be harmful to the environment, and requires significant safety measures. As such, there is a need to provide reliable, cost effective water treatment without the need for expensive and potentially dangerous chemicals.

The mechanical water treatment device utilizing electrical current disclosed herein, may prevent scaling, corrosion, microbiological growth, and fouling from settleable solids without the need for chemical additives. Water circulating through the recirculating water system is passed through the water treatment device where it is exposed to an electrical current between an anode and a rotating cathode. The current causes the water to hydrolyze into hydroxide ions that accumulate at the cathode and hydrogen ions that accumulate at the anode. The hydroxide ions at the cathode cause the pH to rise at the surface. Bicarbonate ions within the area of higher pH are oxidized to carbonate ions that in turn react with calcium ions to form calcium carbonate. Hydrogen ions at the anode readily accept electrons from chloride ions causing the chloride ions to combine to form chlorine.

As the major cause of scaling, calcium carbonate is a problem for recirculating water systems. The water treatment device controls scale by precipitating calcium carbonate and removing it from the system thereby maintaining the concentration of calcium and carbonate ions in the system below the threshold solubility of calcium carbonate.

The water treatment device may prevent corrosion by removing low solubility calcium ions. With low solubility calcium removed, significantly more evaporation per unit of make-up volume may occur since the remaining ions will remain soluble. The corrosion rate of ferrous metals is reduced as total dissolved solids and pH of the water in the system rise. In addition, as the calcium carbonate is precipitated out of solution, other dissolved solids including magnesium and bicarbonate are allowed increase. The increase in magnesium provides natural corrosion inhibition and the increase in alkalinity causes the pH to climb which further reduces the corrosion on steel and other ferrous metals.

The growth of microbiologicals is also controlled by the water treatment device. As stated above, the hydrogen ions at the anode readily accept electrons from the chloride ions causing the chloride ions to combine into chlorine. The chlorine created by the water treatment device oxidizes microbes. The water treatment device also exposes the microbes to extremely high and low pH and permits elevated concentrations of total dissolved solids that reduce the survivorship of microbes entering the system. The water treatment device's use of electrical current may disrupt the cellular metabolism and replication of harmful microbiologicals.

To prevent fouling from settleable solids, the water treatment device may employ a centrifugal separator. This separator not only removes calcium carbonate, but also other suspended solids circulating in the cooling system. The water treatment device may remove substantially all circulating solids larger than about 10 microns.

The water treatment device also offers several advantages over the use of chemical water treatment. The water treatment device eliminates the need to use, store, and handle chemicals including sulfuric acids and toxic biocides. The water treatment device eliminates chemical discharge to the environment and reduces the water usage. Some exemplary embodiments of the water treatment device are fully automated. Exemplary embodiments of the water treatment device may include a tank having a fluid inlet and a fluid outlet. The tank may contain an anode and a cathode. As water enters the tank it is subjected to an electrical current flow between the anode and cathode within the tank. Undesirable minerals such as calcium carbonate begin to precipitate out of solution onto the cathode. A scraping means may be attached to the interior of the tank. The scraping means may extend from the tank inward toward the cathode so as to define a gap between the scraping means and the cathode. An electrical motor may be provided in mechanical communication with the cathode providing rotational motion to the cathode. As the cathode is rotated excess mineral deposits are scraped off by the scraping means as the cathode rotates inside the tank.

In addition to the novel features and advantages mentioned above, other objects and advantages of the present invention will be readily apparent from the following descriptions of the drawings and exemplary embodiments.

### BRIEF DESCRIPTION OF THE DRAWINGS

A better understanding of the disclosed embodiments will be obtained from a reading of the following detailed description and the accompanying drawings wherein identical reference characters refer to identical parts in which:

FIG. 1 is a perspective view of an exemplary embodiment of the water treatment device.

FIG. 2 is an exploded view of an exemplary embodiment of the water treatment device.

FIG. 3 is a cross-sectional view of an exemplary embodiment of the water treatment device having no mineral deposit on the cathode.

FIG. 4 is a cross-sectional view of an exemplary embodiment of the water treatment device having a layer of mineral deposits on the cathode.

FIG. 5 is a diagram illustrating an exemplary embodiment of the water treatment device.

### DETAILED DESCRIPTION OF EXEMPLARY EMBODIMENT(S)

Exemplary embodiments are directed toward a water treatment device and a system and method of water treatment utilizing the water treatment device. Exemplary embodiments may be used with recirculating water systems or any other system where there is a need for water treatment.

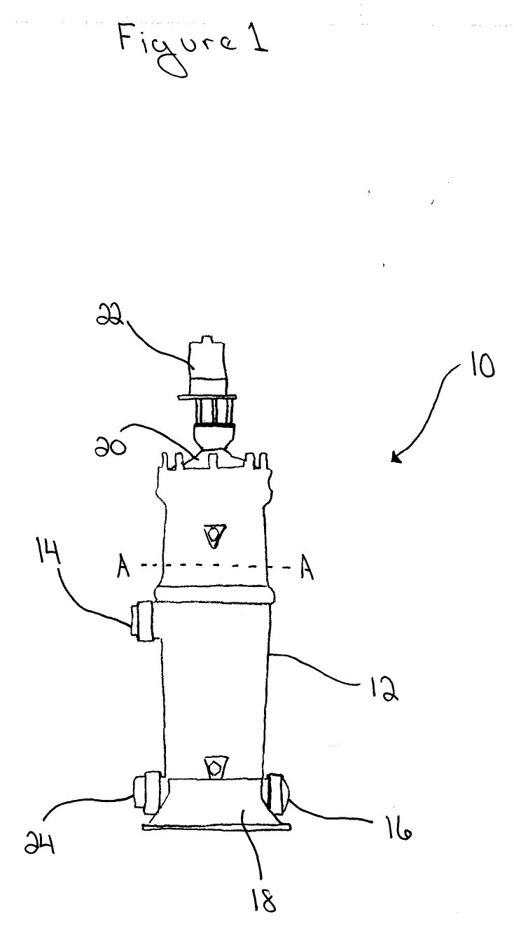

FIG. 1 illustrates an exemplary embodiment of the water treatment device 10. The water treatment device 10 may have a tank 12. The tank 12 may be constructed of a plastic material. The use of a plastic material may prevent the corrosion of the interior and exterior of the tank 12. In other embodiments, the tank 12 may be constructed from a metallic material. The metallic material may be coated to prevent corrosion with an epoxy or other suitable material. In still other exemplary embodiments, the tank 12 may be constructed from fiberglass, extruded fiber reinforced plastics, or any other suitable metallic or non-metallic material. The tank 12 may have a solid unitary configuration. In other exemplary embodiment, the tank 12 may have an upper and lower portion joined together with a water tight sealing means. The sealing means may be an adhesive, sealant, or mechanical fasteners providing a water tight seal. The use of a multipart tank 12 may allow easy access to the components contained within the tank 12. The tank 12 may have a substantially cylindrical shape, having an increased diameter through the middle portion. This may increase the efficiency of the water treatment device 10.

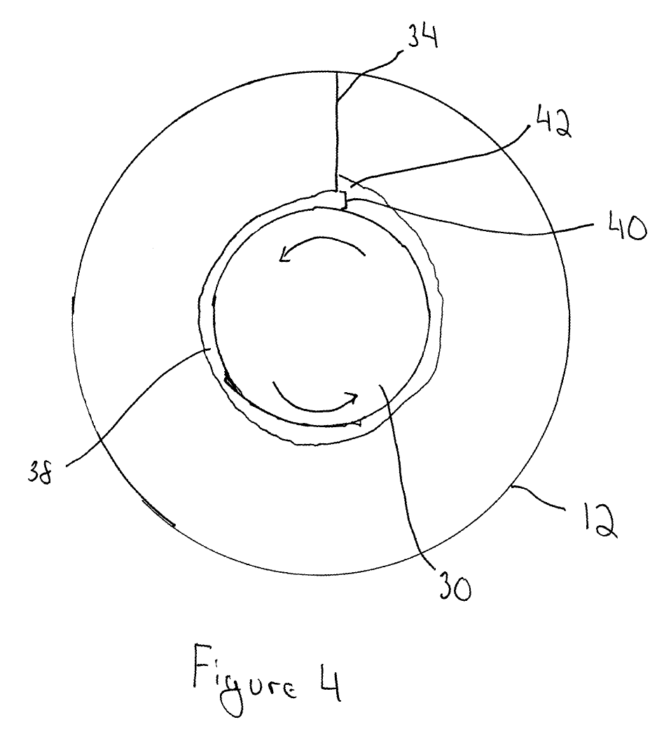

The tank 12 may have a fluid inlet 14. The fluid inlet 14 allows water to enter the tank 12. A fluid outlet 16 may also be located on the tank 12. In the embodiment shown in FIG. 1, the fluid outlet 16 may be located below the fluid inlet 14. In other exemplary embodiments, the fluid inlet 14 may be located below the fluid outlet 16. The fluid outlet 16 allows treated water to exit the water treatment device 10 and reenter the system. The fluid outlet 16 may be located on the tank 12 opposite the fluid inlet 14, or at any other location on the tank 12. The fluid inlet and fluid outlets 14 and 16 may be located at any point around the circumference of the tank 12. This ability to position the fluid inlet and outlet 14 and 16 at any position on the tank 12 ensures that the water treatment device 10 may be used in a variety of water treatment systems. The water treatment device 10 may also have a clean out 24 located on the tank 12. The clean out 24 may facilitate removal of scaling material from the tank 12. The clean out 24 may be used during water treatment to flush any excess scaling material (as shown in FIG. 4) from the system.

To maintain an upright position a stand 18 may be positioned at the bottom of the tank 12. The stand 18 may allow the water treatment device 10 to remain free standing without the need for further support. This may aid in decreasing the space necessary to place and operate the water treatment device 10. In other exemplary embodiments, the water treatment device 10 may be positioned horizontally. Whether in a vertical or horizontal position, a stand 18 may be employed to stabilize the water treatment device 10. In still other exemplary embodiments, the water treatment device 10 may be a rack mounted in either a horizontal or vertical position.

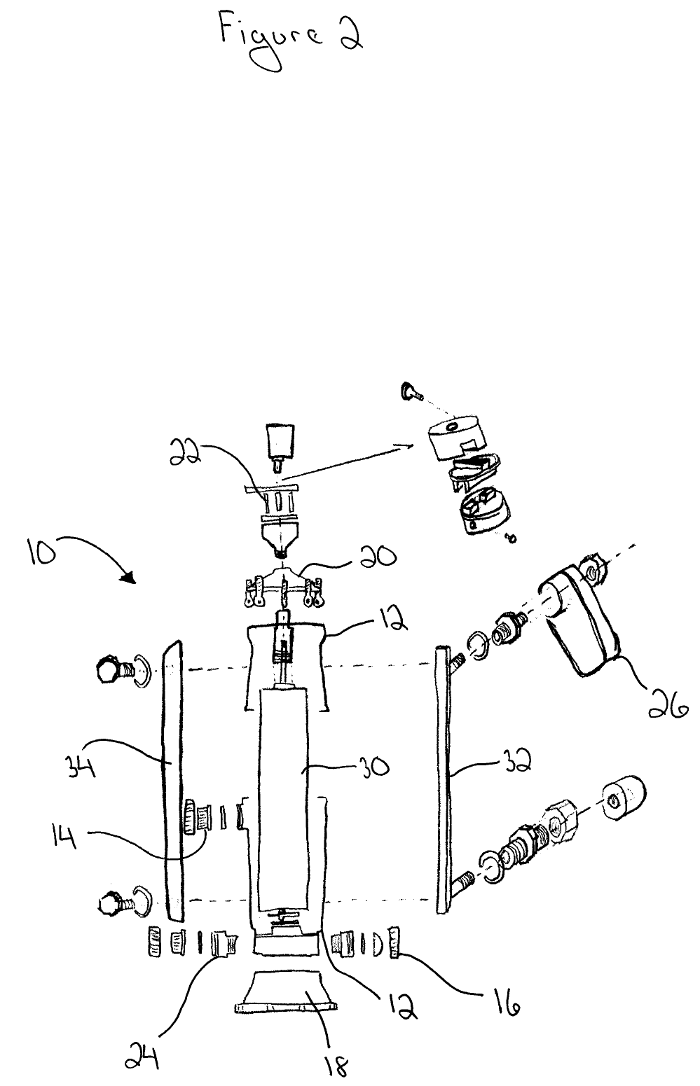

A cap 20 may be provided along the top portion of the tank 12. The cap 20 may be joined to the tank 12 by a water tight means, such as adhesives, sealants, or mechanical device providing a water tight seal. A motor 22 may be affixed to the cap 20. The motor 22 may provide the means necessary for movement of the components within the tank 12. To control the components within the tank 12, the motor 22 interfaces with the components within the tank 12. The motor 22 may be any electrical powered motor capable of providing rotational motion to the cathode 30 (as shown in FIG. 2) of other component to be rotated. The cathode 30 may rotate about its longitudinal axis. In other exemplary embodiments, the tank 12 may be formed to create a cap portion, eliminating the need for a separate cap 20. This embodiment would eliminate the need for additional water tight seals.

As shown in FIG. 2, the motor 22 is connected to the cathode 30 through the cap 20. The motor 22 may be fixed to the cap 20 in a water tight manner. The motor 22 provides rotational motion to the cathode 30. The cathode 30 and motor 22 may be joined together using an electrically isolated coupling. The electrically isolated coupling prevents the motor 22 from being electrically active in the hydrolysis cell. As shown in the figures, the cathode 30 is positioned so as to run through the center of the tank 12. In other exemplary embodiments, the cathode 30 may be positioned at any location within the tank 12. In some embodiments, the cathode 30 may have a cylindrical shape. The cathode 30 may be rotatably fixed to the bottom portion of the tank 12 providing stability during operation. An anode 32 is also placed in the tank 12. The anode 32 may be affixed to a side of the tank 12. The anode 32 may also be in communication with a control unit (not shown in the figures). The control unit provides constant current to the water treatment device 10, and may be mounted remotely on a wall or other structure near the water treatment device 10. The control unit may be electrically connected to the anode 32 and cathode 30. To facilitate the electrical connections a pull box 26 may be used. It should be understood by those skilled in the art that any number of anodes 32 may be used and the positioning may be changed based on the system requirements.

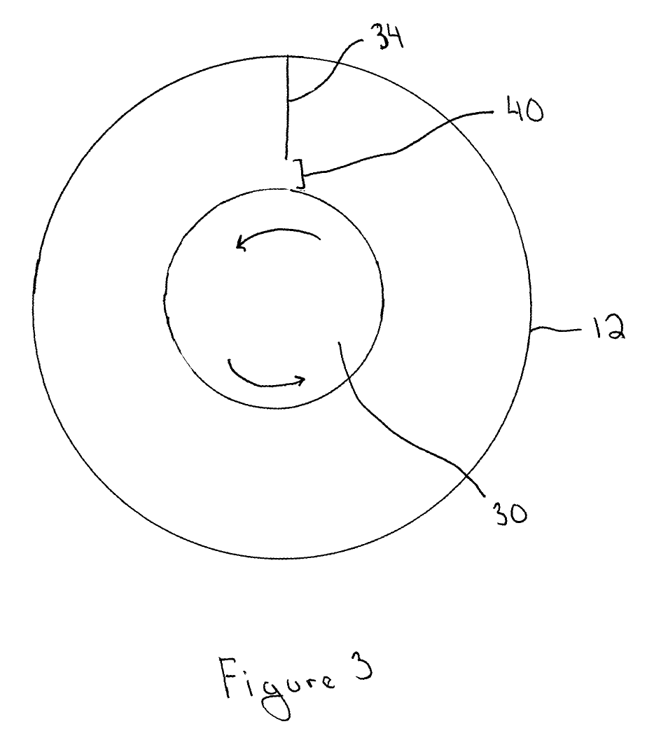

As water enters the tank 12, it is exposed to electrical current between the cathode 30 and anode 32. The current causes the water to hydrolyze into hydroxide ions that accumulate at the cathode 30 and hydrogen ions that accumulate at the anode 32. The hydroxide ions at the cathode 30 cause the pH to rise at that surface. Bicarbonate ions within the area of higher pH are oxidized to carbonate ions that in turn react with calcium ions to form calcium carbonate. The calcium carbonate may then precipitate out of solution onto the cathode 30. This removal of calcium carbonate from the water decreases scaling in the system. Although described using the example of calcium carbonate removal, one skilled in the art would understand that any metal or mineral forming scale may precipitate out of solution onto the cathode 30. To remove portions of the scale from the system a scraping means 34 may be affixed to the interior of the tank 12. The scraping means 34 may run the length of the cathode 30 and is positioned so as to form a gap 40 (as shown in FIG. 3) between the scraping means 34 and the cathode 30. In some exemplary embodiments, the gap 40 defined by the scraping means 34 and the cathode 30 may be in a range between about 1/16 of an inch to about ¼ of an inch. In other exemplary embodiments, the gap 40 may be in a range between about ⅛ of an inch to about ¼ of an inch. In still other exemplary embodiments, the gap 40 may be about ⅛ of an inch.

During operation of the water treatment device 10, scale builds up on the cathode 30 filling the gap 40 between the scraping means 34. Once the depth of the scale is greater than the gap 40 between the scraping means 34 and the cathode 30, the scale comes into contact with the scraping means 34 and is removed from the cathode 30. This scale removal process is possible because of the rotational motion of the cathode 30. As the cathode 30 rotates, the stationary scraping means 34 removes the excess scale 42. A layer of scale 38 (as shown in FIG. 4) substantially equal to the gap 40 between the scraping means 34 and the cathode 30 remains on the cathode 30 preventing corrosion of the cathode 30. The scraping means 34 may be constructed of durable material able to withstand removing the excess scale 42; such materials may include, but are not limited to metals, hard plastics, resins or other suitable materials, that may be shaped in the form of a chisel or a knife blade, among other suitable configurations.

This is further illustrated in FIGS. 3 and 4, which is a cross section of water treatment device at line AA, as seen in FIG. 1. FIG. 3 illustrates the cathode 30 having no mineral deposits thereon. FIG. 4 illustrates the cathode 30 during operation of the water treatment device 10 having scaling deposits thereon. A stationary scraping means 34 extends from the tank 12 inward toward the cathode 30 without contacting the cathode 30 so as to define a gap 40.

During operation of the water treatment device 10, a layer of scale 38 and other undesirable minerals form on the cathode 30. A stationary scraping means 34 extends from the tank 12 inward toward the cathode 30 without contacting the cathode 30 so as to define a gap 40 (shown in FIG. 3) between the distal end of the scraping means 34 and the cathode 30. As the water treatment device 10 continues to operate, the layer of scale 38 increases in depth. Once the depth of the scale layer 38 is greater than the gap 40 between the scraping means 34 and the cathode 30, the excess scale 42 is removed from the layer of scale 38. As the cathode 30 rotates the excess scale 42 is scraped off by the stationary scraping means 34. The remaining layer of scale 38 may have a depth substantially equal to the gap 40 between the scraping means 34 and the cathode 30. After the removal of the excess scale 42 from the cathode 30, the excess falls to the bottom of the tank to be filtered out of the system.

By providing a rotating cathode 30 and a stationary scraping means 34 the water treatment device 10 is able to continuously remove excess precipitated scale forming material from the water in the system, without the need to stop treatment to remove excess particulates. This represents a significant advantage over other water treatment systems.

In other exemplary embodiments of the water treatment device 10, the motor 22 may be in connected to the scraping means 34, and the cathode 30 may be stationary inside the tank 12. In this configuration, the scraping means 34 may rotate around the cathode 30 removing excess scale deposits 42. In still other exemplary embodiments, both the scraping means 34 and the cathode 30 may be in communication with the motor 22. In this manner, the cathode 30 and scraping means 34 may rotate in opposing directions or in the same direction at differing speeds to facilitate removal of the excess scaling material 42. The different embodiments described above all allow the water treatment device 10 to remove excess mineral deposits without the need to stop treatment of the water.

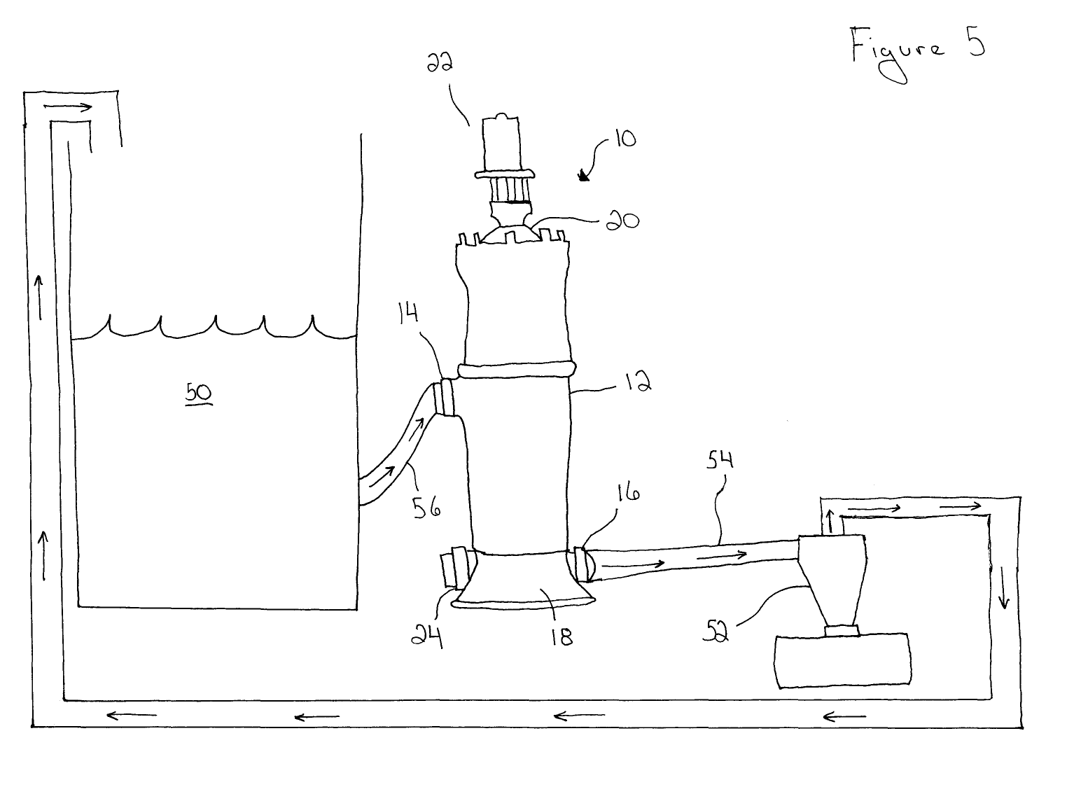

Once the excess scale 42 is removed from the cathode 30 it may be filtered out of the system. As the water to be treated passes through the water treatment device 10, for example, at about 125 gallons per minute, the rotation of the components in the tank 12, the shape of the tank 12, gravity, and the force of the water may drive the removed excess scaling material 42 from the tank 12 through the fluid outlet 16 to be removed from the system. As shown in FIG. 5, a separator 52 may be located in the fluid return line 54. The separator 52 may be a centrifugal separator, although other suitable separators may be employed. The separator 52 directs the incoming water into a vortex forcing the removed excess scaling material 42 from the system. In addition, the separator 52 may also remove dust and debris entrained in the cooling tower 50 during normal operation. In this manner, the water treatment device 10 does not require a media filter to remove the excess scaling material 42 from the system. Although it should be understood that a media filter may be used with the water treatment device 10. By passing the removed excess scaling material 42 from the water treatment device 10 into the separator 52, there is no need to stop water treatment to remove the excess scaling material 42 from the tank 12. In other exemplary embodiment, a separator 52 may also be placed in the fluid supply line 56.

The water treatment device 10 may be used in-line with any recirculating water system. In other exemplary embodiments, the water treatment device may be used in a side stream configuration. An example of a recirculating water system employing an exemplary embodiment of the water treatment system 10 may be seen in FIG. 5. As shown in FIG. 5, the water treatment device 10 may be used to constantly treat water in a holding tank 50. The water flows from the holding tank 50 through the water treatment device 10 and the treated water is carried back to the holding tank 50. Although FIG. 5 illustrates a single water treatment device 10 one skilled in the art would appreciate the ability to arrange multiple water treatment devices 10 in series or parallel depending on the treatment needs of the system.

Any exemplary embodiment may include any of the optional or preferred features of the other embodiments. The exemplary embodiments herein disclosed are not intended to be exhaustive or to unnecessarily limit the scope of the invention. The exemplary embodiments were chosen and described in order to explain the principles of the claimed invention so that others skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A water treatment device, comprising:
a tank having a fluid inlet and a fluid outlet;
an anode located within said tank;
a cathode located with said tank, said cathode rotating about its longitudinal axis; and
a scraping means located within the tank positioned so as to define a gap between the said scraping means and said cathode.

2. The water treatment device of claim 1, wherein said cathode is in mechanical communication with an electric motor.

3. The water treatment device of claim 1, wherein said scraping means is fixed to the interior wall of the tank, extending inward toward said cathode.

4. The water treatment device of claim 2, wherein said electric motor imparts rotational motion to said cathode.

5. The water treatment device of claim 1, further comprising a control unit for supplying constant current for the treatment of water.

6. The water treatment device of claim 1, wherein said tank is a plastic material.

7. A water treatment device, comprising:
a tank having a fluid inlet and a fluid outlet;
an anode located within said tank;
a cathode located within said tank; and
a scraping means located within said tank, wherein one or both of the said cathode and said scraping means rotate about a central axis.

8. The water treatment device of claim 7, wherein said central axis is the longitudinal axis of said cathode.

9. The water treatment device of claim 7, wherein said cathode rotates about said central axis and said scraping means is stationary.

10. The water treatment device of claim 7, wherein said cathode is stationary and said scraping means rotates about said central axis.

11. The water treatment device of claim 7, wherein said cathode and said scraping means rotate about said central axis in opposite directions.

12. The water treatment device of claim 7, wherein said cathode and said scraping means rotate about said central axis in the same direction at different speeds.

13. The water treatment device of claim 7, wherein said tank is a plastic material.

14. The water treatment device of claim 7, further comprising a control unit providing constant current for the treatment of water.

15. The water treatment device of claim 7, further comprising an electric motor providing rotational motion one or both of said cathode and scraping means.

16. The water treatment device of claim 7, wherein said scraping means is a durable plastic material.

17. A water treatment method, comprising:
providing a tank having an anode and cathode located therein, said tank further comprising a scraping means located therein, said scraping means positioned so as to define a gap between said cathode and said scraping means;
passing water to be treated through said tank;
precipitating scaling material from the water to be treated onto said cathode;
continuously rotating said cathode about its longitudinal axis; and
removing excess scaling material from said cathode while continuously treating water passing through said tank.

18. The method of claim 17, wherein said tank is a plastic material.

19. The method of claim 17, wherein said cathode is in mechanical communication with a electric motor, said electric motor imparting rotational motion to said cathode.

20. The method of claim 17, further comprising providing a control unit providing a constant current for the treatment of water.
